(19) United States
(12) Patent Application Publication
(10) Pub. No.: US 2008/0012867 A1
(43) Pub. Date: Jan. 17, 2008

(54) SYSTEM AND METHOD FOR REPRESENTING OPERATION INFORMATION

(75) Inventor: Sheng-Jin Hsieh, Hsinchu City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MEDIATEK INC., Hsin-Chu City (TW)

(21) Appl. No.: 11/456,786

(22) Filed: Jul. 11, 2006

(51) Int. Cl. G06F 15/00

(52) U.S. Cl. 345/501

(57) ABSTRACT

A system and a method for representing operation information of a first subsystem while a second subsystem is still running are provided. At least one of the first subsystem and the second subsystem is a multimedia subsystem or an optical storage subsystem. A memory stores the operation information of the first subsystem when the first subsystem is running. A processor runs the second subsystem. An interface receives a control signal which is generated by a user. Then a display device represents the operation information in response to the control signal while the second subsystem is running.

### CROSS-REFERENCES TO RELATED APPLICATIONS

Not applicable.

### BACKGROUND OF THE INVENTION

1. Field of the Invention

The present invention relates to a system and a method for representing operation information; in particular, the invention relates to a system and a method for representing operation information of a subsystem while another subsystem is still running.

2. Descriptions of the Related Art

Many multimedia playback systems in the market currently integrate various multimedia subsystems, such as televisions, optical disk players, globe position systems (GPS), etc., which allow users to get information from various kinds of subsystems using only one user interface. The aforementioned optical disk player is currently compatible with, for example, compact disks (CD), video compact disks (VCD), digital versatile disks (DVD), blu-ray disks (BD) and/or the like.

U.S. Pat. No. 5,228,021 discloses a display apparatus for a multidisk player. The multidisk player comprises a memory for storing information from disks and a controller for reading and displaying the information on a display. As shown in FIG. 1, the information comprises orders of the disks 11, titles of the disks 13, multimedia formats of the disks 15, and numbers of tracks in the disks 17. A user can obtain the information of each disk at a glance without playing it.

U.S. Pat. No. 5,508,984 discloses an optical disk player as shown in FIG. 2. The optical disk player 2 comprises a disk mechanism 21, a disk record unit 23, a controller 25, a data RAM 27, and an information RAM 29. The disk mechanism 21 rotates a disk for reading and writing data and information from and to the disk 21a. The data can be a song, for example, while the information comprises a title, track number, lapsed time, and the like of the song. The disk record unit 23 compresses data and stores the compressed data in the data RAM 27 when recording the data. The disk record unit 23 further decodes the information and sends the decoded information to the controller 25. The controller 25 then stores the decoded information in the information RAM 29. When a user needs to access the data and information, the compressed data and the decoded information are retrieved from the data RAM 27 and the information RAM 29, respectively. At that point, both the compressed data and the decoded information are sent for playing.

Both of the aforementioned patents are capable of displaying information of display systems. However, they both fail to disclose an apparatus or method for representing operation information when the apparatus or the method involves various multimedia display subsystems. For example, when using GPS navigation during car driving, a user needs to power off the GPS system and power on an optical disk player if the user wants to listen to music. This switch can be rather inconvenient. Therefore, a solution for representing operation information of one subsystem while another subsystem is running is needed in this industrial field.

### SUMMARY OF THE INVENTION

An object of this invention is to provide a system for representing operation information. The system comprises a first subsystem, a second subsystem, a memory, a processor, an interface, and a display device. The memory is configured to store the operation information of the first subsystem when the first subsystem is running. The processor is configured to run the second subsystem. The interface is configured to receive a control signal. The display device is configured to represent the operation information in response to the control signal while the second subsystem is running. At least one of the first subsystem and the second subsystem is a multimedia subsystem.

Another object of this invention is to provide a method for representing operation information of a first subsystem while a second subsystem is running, wherein at least one of the first subsystem and the second subsystem is a multimedia subsystem. The method comprises the steps of: storing the operation information when the first subsystem is running; running the second subsystem; receiving a control signal; and representing the operation information in response to the control signal while the second subsystem is running.

Another object of this invention is to provide a system for representing operation information. The system comprises a first subsystem, a second subsystem, a memory, a processor, an interface, and a display device. The memory is configured to store the operation information of the first subsystem when the first subsystem is running. The processor is configured to run the second subsystem. The interface is configured to receive a control signal. The display device is configured to represent the operation information in response to the control signal while the second subsystem is running. At least one of the first subsystem and the second subsystem is an optical storage subsystem.

Another object of this invention is to provide a method for representing operation information of a first subsystem while a second subsystem is running. At least one of the first subsystem and the second subsystem is an optical storage subsystem. The method comprises the steps of: storing the operation information when the first subsystem is running; running the second subsystem; receiving a control signal; and representing the operation information in response to the control signal while the second subsystem is running.

Another object of this invention is to provide a system for representing operation information. The system comprises a first subsystem; a second subsystem; means for storing the operation information of the first subsystem when the first subsystem is running; means for running the second subsystem; means for receiving a control signal; and means for representing the operation information in response to the control signal while the second subsystem is running. At least one of the first subsystem and the second subsystem is a multimedia subsystem.

Yet a further object of this invention is to provide a system for representing operation information. The system comprises a first subsystem; a second subsystem; means for storing the operation information of the first subsystem when the first subsystem is running; means for running the second subsystem; means for receiving a control signal; and means for representing the operation information in response to the control signal while the second subsystem is running. At least one of the first subsystem and the second subsystem is an optical storage subsystem.

The present invention is capable of obtaining operation information of the first subsystem without running the first subsystem. It can also do this while the second subsystem is running.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows an example of displaying operation information in the prior art;

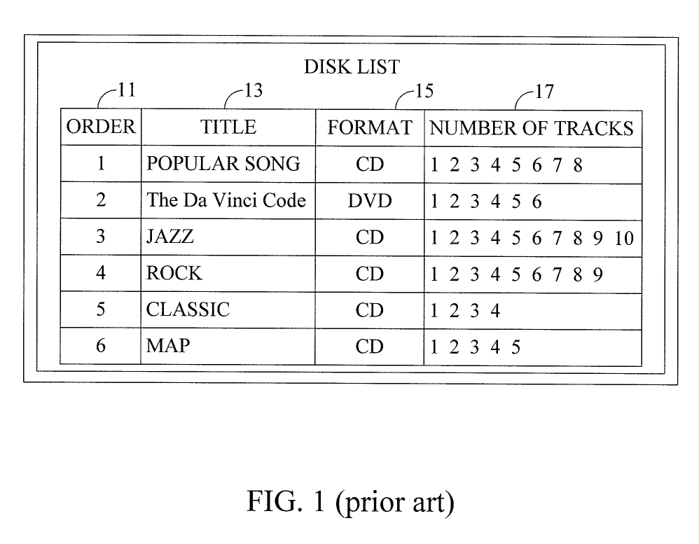

FIG. 2 shows a block diagram of an optical disk player of the prior art;

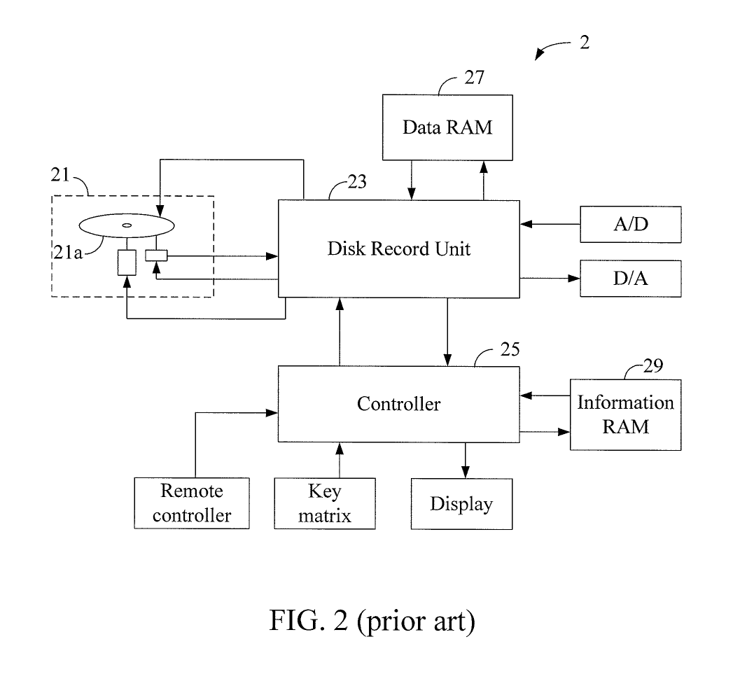

FIG. 3 shows a first embodiment in accordance with the present invention;

FIG. 4 shows an example of displaying operation information in accordance with the present invention;

FIG. 5 shows a flow chart of a second embodiment in accordance with the present invention; and

FIG. 6 shows a further flow chart of the second embodiment in accordance with the present invention

### DESCRIPTION OF THE PREFERRED EMBODIMENT

In this specification, the term “in response to” is defined as “replying to” or “reacting to.” For example, “in response to a signal” means “replying to a signal” or “reacting to a signal” without necessity of direct signal reception.

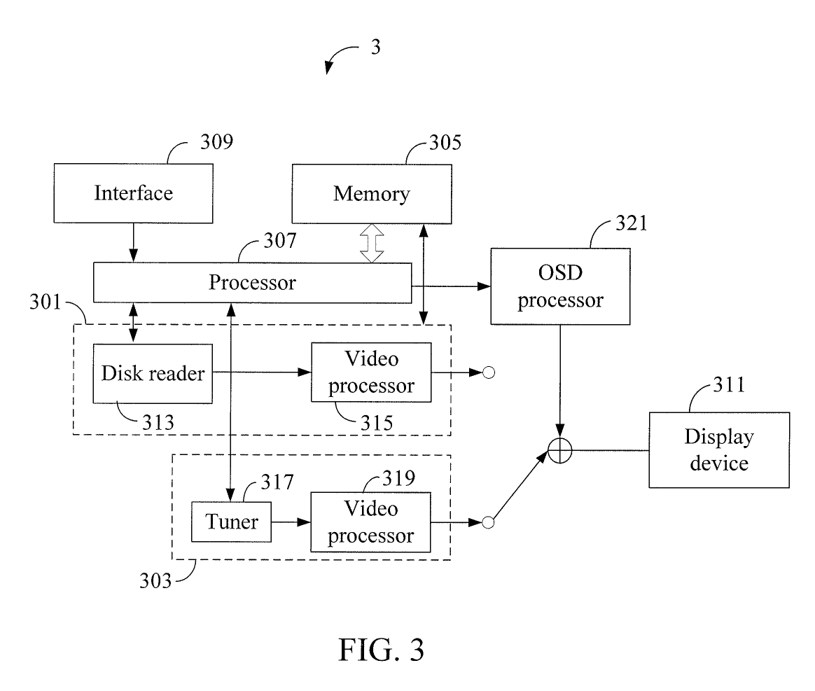

FIG. 3 shows a first embodiment of the present invention, in which a system 3 for representing operation information of a subsystem is shown with another subsystem simultaneously running. The system 3 comprises a first subsystem 301, a second subsystem 303, a memory 305, a processor 307, an interface 309, and a display device 311. In this embodiment, the first subsystem 301 is, but not necessarily limited to, an optical storage subsystem for playing multimedia, which comprises a disk reader 313 and a video processor 315. More particularly, the first subsystem 301 is CD, VCD, and DVD compatible. The second subsystem 303 may be, for example, an optical storage subsystem, a GPS navigation subsystem, or a television source. For example, the second subsystem 303 can be a TV playing subsystem which comprises a tuner 317 and a video processor 319.

When a disk is inserted into the first subsystem 301, the first subsystem 301 automatically runs so that the disk reader 313 can retrieve original operation information thereof. The original operation information comprises, for example, the titles of the items in the disk, formats of the disk, and number of tracks in the disk. The original operation information is stored in the memory 305. The user might then play the second subsystem 303 to watch TV. In such a case, the processor 307 runs the second subsystem 303. Once the user desires the operation information of the first subsystem 301, the user may input a control signal via a remote controller (not shown) to control the system 3. After the interface 309 receives the control signal, the display device 311 represents the original operation information in response to the control signal while the second subsystem 303 is running.

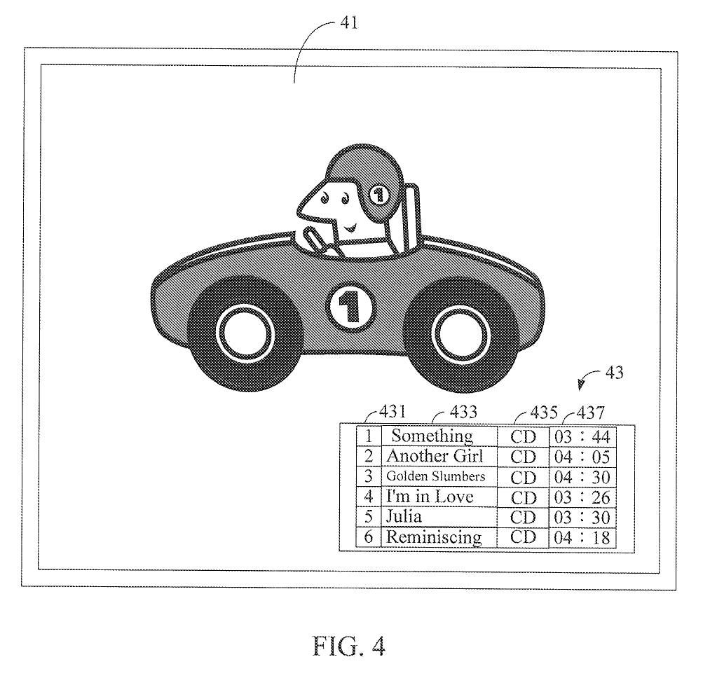

The system 3 further comprises an OSD processor 321 for displaying an OSD. When the display device 311 is required to represent the original operation information, the processor 307 controls the OSD processor 321 to display the original operation information in the OSD. The user is, hence, able to obtain the operation information of the first subsystem 301 visually without actually re-running the first subsystem 301. In the first embodiment, the operation information may be arranged as a table as FIG. 4 shows, wherein a TV program 41 retrieved from the second subsystem 303 is still displayed while the table 43 represent the original operation information. The table 43 comprises a column 431 for showing the order of the items, a column 433 for showing the titles of the items, a column 435 for showing the formats of the items and a column 437 for showing the lengths of the items.

Rather than using an OSD, the operation information may be displayed directly in the foreground while the TV program 41 is displayed in the background.

If there is no disk in the first subsystem 301 when the user inputs the control signal, the display device 311 would display “no disk.”

If the user plays one of the items in the disk at the outset and pauses or stops the playing before the end of the item, an update of the operation information is generated because a status of the first subsystem 301 has been changed. The update comprises, for example, the title of the paused or stopped item and the paused or stopped timing. This update will overwrite the original operation information. When the user inputs the control signal later, the update is displayed instead of the original operation information.

Rather than visual display, the operation information may also be performed auditively. For example, the system 3 plays a voice sound to inform the user of the operation information while the second subsystem 303 is running.

A second embodiment of the present invention is a method for representing operation information of a first subsystem while a second subsystem is running. The method is adapted for a system, such as the aforementioned system 3.

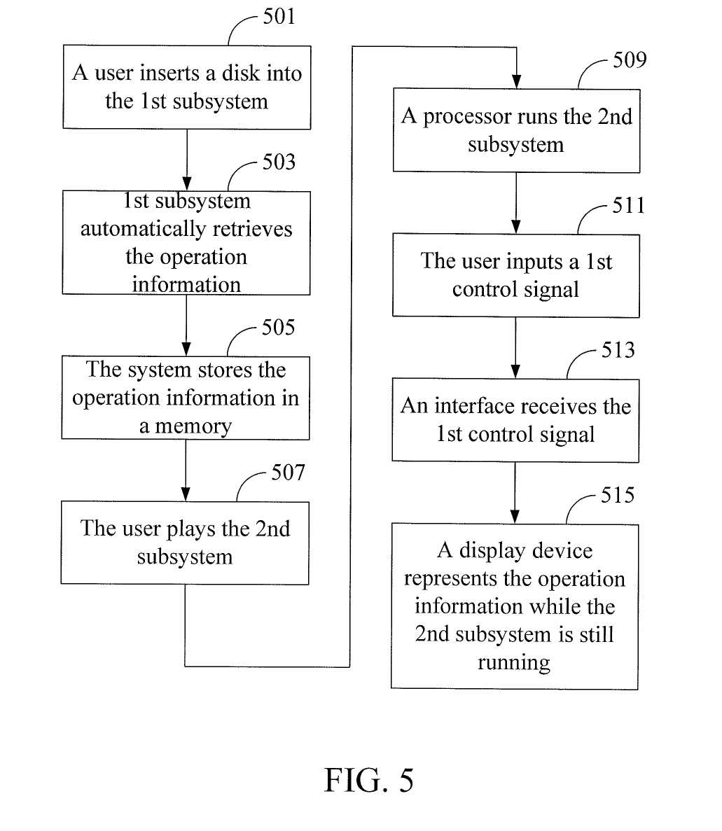

FIG. 5 shows a flow chart of the method. In step 501, a disk is inserted into the first subsystem like the first subsystem 301. In step 503, the first subsystem automatically retrieves the operation information thereof. In step 505, the operation information is stored in a memory like the memory 305. Step 507 is then executed in which the user plays the second subsystem like the second subsystem 303 to watch TV. In step 509, a processor like the processor 307 runs the second subsystem 303. Then, step 511 is executed in which the user inputs a first control signal via a remote controller. In step 513, an interface like the interface 309 receives the first control signal. In step 515, a display device like the display device 311 represents the operation information in response to the first control signal while the second subsystem is still running.

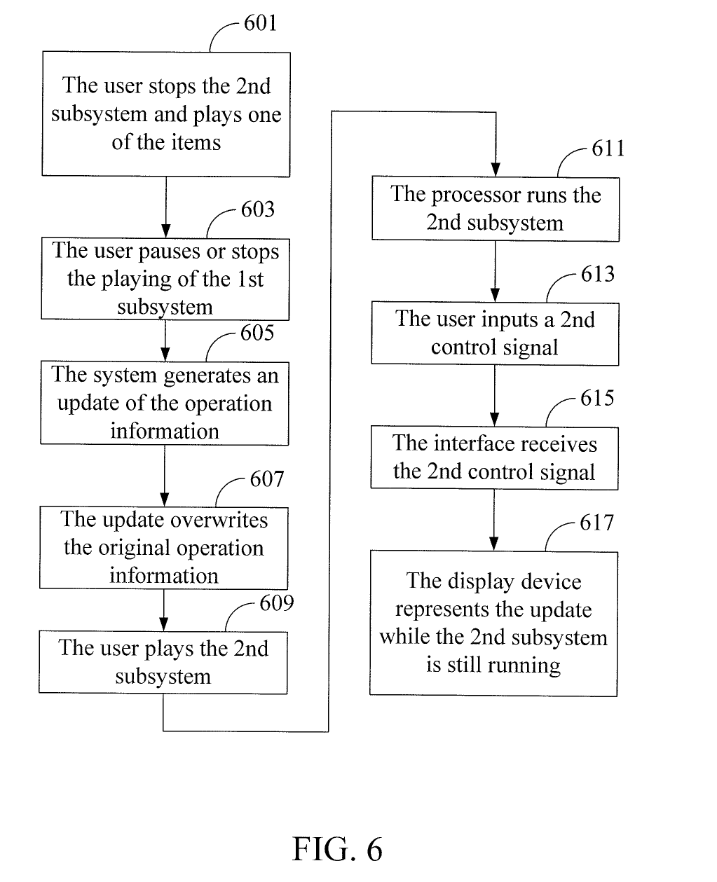

FIG. 6 shows a subsequent flow chart of the method. In step 601, the user stops the second subsystem and plays one of the items in the disk inserted in the first subsystem. The user enjoys the disk for a while. Then step 603 is executed in which the user pauses or stops the playing of the first subsystem. In step 605, an update of the original operation information is generated. In step 607, the update overwrites the original operation information stored in step 505. Step 609 is then executed in which the user plays the second subsystem to watch TV. In step 611, the processor runs the second subsystem. Then, step 613 is executed in which the user inputs a second control signal via the remote controller. In step 615, the interface receives the second control signal. In step 617, the display device represents the update in response to the second control signal while the second subsystem 303 is still running.

In addition to the steps shown in FIG. 5 and FIG. 6, the second embodiment may perform all of the operations and functions recited in the first embodiment.

Generally speaking, the start-up of a multimedia subsystem or an optical storage subsystem takes time. By storing the operation information of the first subsystem while the first subsystem is running, the present invention is capable of displaying the operation information while the second subsystem is running without re-running the first subsystem. The user may, hence, obtain the operation information of the first subsystem promptly. In addition, power is saved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A system for representing operation information, comprising:
a first subsystem;
a second subsystem;
a memory for storing the operation information of the first subsystem when the first subsystem is running;
a processor for running the second subsystem;
an interface for receiving a control signal; and
a display device for representing the operation information in response to the control signal while the second subsystem is running;
wherein one of the first subsystem and the second subsystem is a multimedia subsystem.

2. The system as claimed in claim 1, wherein an update of the operation information is stored in the memory, and the display device represents the update in response to the control signal.

3. The system as claimed in claim 2, wherein the update is generated when a status of the first subsystem is changed.

4. The system as claimed in claim 1, wherein the operation information is represented auditively.

5. The system as claimed in claim 1, wherein the operation information is represented visually.

6. The system as claimed in claim 1, wherein the operation information is retrieved from an optical storage medium.

7. A method for representing operation information of a first subsystem while a second subsystem is running, one of the first subsystem and the second subsystem being a multimedia subsystem, comprising:
storing the operation information when the first subsystem is running;
running the second subsystem;
receiving a control signal; and
representing the operation information in response to the control signal while the second subsystem is running.

8. The method as claimed in claim 7, further comprising a step of updating the operation information.

9. The method as claimed in claim 8, wherein the updating step is executed when a status of the first subsystem is changed.

10. The method as claimed in claim 7, wherein the operation information is represented auditively.

11. The method as claimed in claim 7, wherein the operation information is represented visually.

12. The method as claimed in claim 7, wherein the operation information is retrieved from an optical storage medium.

13. A system for representing operation information, comprising:
a first subsystem;
a second subsystem;
a memory for storing the operation information of the first subsystem when the first subsystem is running;
a processor for running the second subsystem;
an interface for receiving a control signal; and
a display device for representing the operation information in response to the control signal while the second subsystem is running;
wherein one of the first subsystem and the second subsystem is an optical storage subsystem.

14. The system as claimed in claim 13, wherein an update of the operation information is stored in the memory, and the display device represents the update in response to the control signal.

15. The system as claimed in claim 14, wherein the update is generated when a status of the first subsystem is changed.

16. The system as claimed in claim 13, wherein the operation information is represented auditively.

17. The system as claimed in claim 13, wherein the operation information is represented visually.

18. The system as claimed in claim 13, wherein the operation information is related to a multimedia file.

19. A method for representing operation information of a first subsystem while a second subsystem is running, one of the first subsystem and the second subsystem being an optical storage subsystem, comprising:
storing the operation information when the first subsystem is running;
running the second subsystem;
receiving a control signal; and
representing the operation information in response to the control signal while the second subsystem is running.

20. The method as claimed in claim 19, further comprising a step of updating the operation information.

21. The method as claimed in claim 20, wherein the updating step is executed when a status of the first subsystem is changed.

22. The method as claimed in claim 19, wherein the operation information is represented auditively.

23. The method as claimed in claim 19, wherein the operation information is represented visually.

24. The method as claimed in claim 19, wherein the operation information is related to a multimedia file.

25. A system for representing operation information, comprising:
a first subsystem;
a second subsystem;
means for storing the operation information of the first subsystem when the first subsystem is running;
means for running the second subsystem;
means for receiving a control signal; and
means for representing the operation information in response to the control signal while the second subsystem is running;
wherein one of the first subsystem and the second subsystem is a multimedia subsystem.

26. A system for representing operation information, comprising:
a first subsystem;
a second subsystem;
means for storing the operation information of the first subsystem when the first subsystem is running;
means for running the second subsystem;
means for receiving a control signal; and
means for representing the operation information in response to the control signal while the second subsystem is running;
wherein one of the first subsystem and the second subsystem is an optical storage subsystem.
